(19) United States
(12) Patent Application Publication
(10) Pub. No.: US 2007/0023097 A1
(43) Pub. Date: Feb. 1, 2007

(54) Underground pipe for transporting fuel and a method of fabricating it

(75) Inventor: Pierre Milhas, Vitry-Le-Francois (FR)

Correspondence Address: DYKEMA GOSSETT PLLC, 39577 Woodward Avenue, Suite 300, Bloomfield Hills, MI, 48304, US

(73) Assignee: NOBEL PLASTIQUES

(21) Appl. No.: 11/496,793

(22) Filed: Aug. 1, 2006

(30) Foreign Application Priority Data
Aug. 1, 2005 (FR) 0508195

(51) Int. Cl. F16L 11/00

(52) U.S. Cl. 138/113; 138/121; 138/137; 138/125

(57) ABSTRACT

The present invention relates to a pipe for transporting fuel, the pipe comprising an inner tube and an outer tube that are coaxial with a space being maintained between them by spacer means, the outer tube comprising an outer layer and an inner layer, the inner layer being helically corrugated and free relative to the inner tube so as to form the spacer means. The invention also provides a method of fabricating said pipe.

The present invention relates to an underground pipe for transporting fuel. The invention also relates to a method of fabricating such a pipe.

### BACKGROUND OF THE INVENTION

Fuel is distributed to users by means of service stations installed along roads for automobile activities, in ports for maritime activities, or in depots for aviation and domestic applications.

A service station generally comprises storage tanks including one or more distribution pumps, and a zone that is for receiving the vehicle and that is fitted with delivery pumps.

The functions of the distribution pumps are to supply fuel to the delivery pumps and to mix fuels so as to obtain a desired octane rating. In particular, in the United States, three grades of gasoline are available at the pump (96, 97, and 98 octane), but stations only have two tanks (96 and 98), with the third grade of gasoline being obtained by a 50/50 mixture of the other two grades of gasoline. Thus, there is no direct delivery of fuel having the intermediate octane rating, thereby reducing infrastructure and management costs.

The distribution pump is contained in a stand located close to the vehicle and it is directly connected to the filler nozzle.

A set of stationary pipes connects the various elements together, and in particular connects the tanks to the distribution pumps and the distribution pumps to the delivery pumps. The pipes usually have diameters lying in the range 1.27 centimeters (cm) to 6.35 cm.

The pipes used in such a set are of two types: rigid pipes made of steel or glass fiber reinforced polymer; and flexible pipes made up of multiple layers, mostly of polymers.

A flexible pipe is constituted by two coaxial multilayer tubes, one being contained in the other. The inner tube is referred to as the primary pipe and the outer tube is referred to as the containment pipe.

The inner tube serves to convey fuel (gasoline, diesel, kerosene, . . . ). It is made up of a series of coaxial layers of extruded polymers (polyamides, polyethylenes, fluorinated polymers, . . . ) optionally including reinforcing layers (braids, aluminum tapes, . . . ). In general a tandem multilayer extrusion method is used.

In the event of the inner tube failing, the outer tube serves to avoid contaminating the ground. A space is left between the inner tube and the outer tube to make it easier to remove any fuel that is to be found therein. The quantity of fuel occupying this space is thus periodically monitored, avoiding ground contamination by seepage or permeability phenomena. The outer tube is made up of one or more layers of extruded polymers, with or without reinforcement depending on the manufacturer. The intermediate space is maintained by longitudinal ribs that hold the two tubes spaced apart from each other and that are generally obtained by extrusion through a die of crenellated shape. The materials used are mainly polyolefins.

The set of technical requirements (permeability, bursting strength, resistance to fluids, . . . ) is given in Specification UL971.

With recent changes in environmental standards, the polymer tube constructions that have been used until now no longer satisfy Specification UL971. Two new criteria in particular have made nearly all existing products obsolete: firstly permeability to fuel (a phenomenon of evaporation through the walls of the tube and thus synonymous with pollution), and, secondly, variation in the length of the tube when immersed in the fuel. This criterion is important since numerous instances have been reported in which by shrinking or lengthening due to aging, the tube has caused connectors to rupture, thereby leading to large amounts of on-site pollution.

### OBJECTS AND SUMMARY OF THE INVENTION

The invention relates to a flexible pipe structure that is compatible with the above-specified standard, serving in particular to provide very low levels of permeability or of dimensional change, so as to obtain a pipe that is cleaner and more reliable.

To this end, the invention provides a pipe for transporting fuel, the pipe comprising an inner tube and an outer tube that are coaxial, with a space being maintained between them by spacer means. The outer tube comprises an outer layer and an inner layer, the inner layer being helically corrugated and free relative to the inner tube so as to form the spacer means.

Thus, the space for retaining any fuel that escapes from the inner tube is defined by the corrugations whose helical shape makes it possible to remove that fuel along the pipe when the quantity thereof is excessive. The absence of bonding between the inner and outer tubes also makes it possible to limit the consequences of expansion of the pipe on connectors connecting the pipe to elements of the circuit in which it is included: when the outer tube expands, the corrugations come closer together so the force exerted by the outer tube on the connectors is limited. It is thus possible to ensure that the outer tube exerts a force on the connectors that is equivalent to the force that would be caused by elongation of less than only about 0.2%.

Preferably, the inner layer of the outer tube has a minimum inside diameter greater than the outside diameter of the inner tube.

The lack of bonding between the inner and outer tubes is thus obtained simply, and it is easier to cause any fuel that has leaked from the inner tube to flow along the pipe.

The invention also provides a method of fabricating such a pipe for transporting fuel. The method comprises the steps of:

making an inner tube;

passing the inner tube through an extruder die;

at the outlet from the extruder die, forming helical corrugations around the inner tube in the material being delivered by the die so as to constitute an inner layer of an outer tube that is free relative to the inner tube;

taping the inner layer with a tape so as to form a taped intermediate layer of the outer tube; and

extruding an outer layer of the outer tube.

The tape serves to avoid the material of the outer layer filling the corrugations at the exit from the die, which would otherwise limit the flexibility of the pipe. It is then possible to have an outer layer of relatively small thickness.

### BRIEF DESCRIPTION OF THE DRAWING

Other characteristics and advantages of the invention appear on reading the following description of a particular and non-limiting embodiment of the invention.

Reference is made to the accompanying drawing, in which:

FIG. 1 is a longitudinal section view of a pipe in accordance with the invention; and

FIG. 2 is a diagrammatic view of an extruder unit for fabricating the pipe.

### MORE DETAILED DESCRIPTION

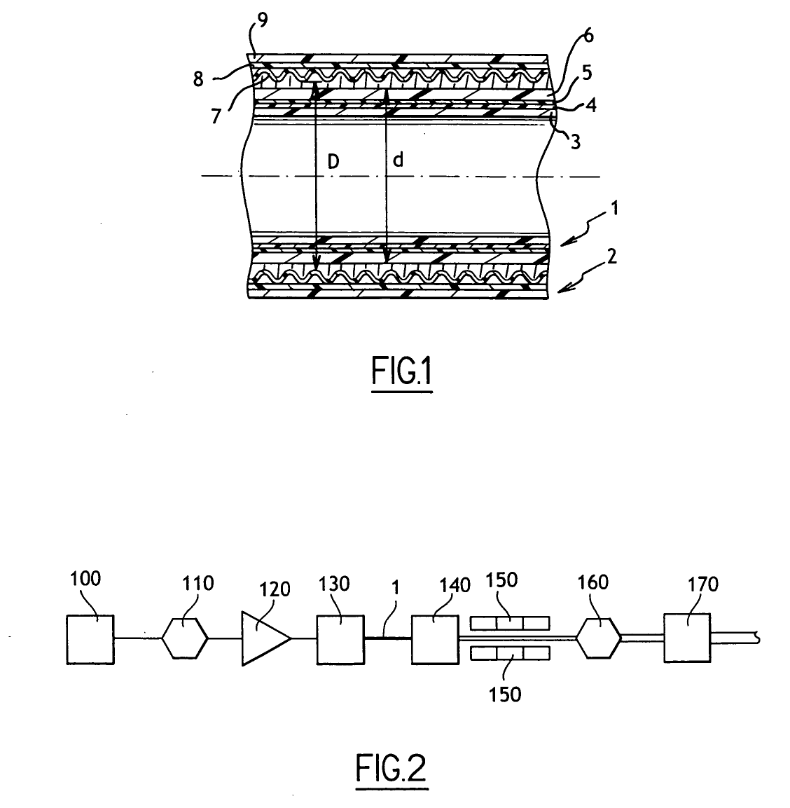

With reference to FIG. 1, the pipe in accordance with the invention comprises an inner tube given overall reference 1, and an outer tube given overall reference 2. The inner tube 1 and the outer tube 2 are coaxial.

The inner tube 1 comprises, from the inside towards the outside: an inner layer 3, a taped intermediate layer 4, mechanical reinforcement 5, and an outer layer 6.

The inner layer 1 is made of polyamide, preferably polyamide 12 (PA12). Because of the desired flexibility, it is preferable to use a plasticized grade, typically plasticized to 12.5%. The thickness of the inner layer lies, for example, in the range 1 millimeter (mm) to 3 mm, depending on diameter.

The intermediate layer 4 is made of an aluminum-coated polyester tape. Typically the tape is made up of two polyester layers having a thickness of a few micrometers (usually 24 micrometers (μm)) sandwiching an aluminum strip having thickness lying in the range 30 μm to 60 μm. This tape is produced, for example, under the name Mylar by the supplier Dupont de Nemours. The tape is laid lengthwise with minimum overlap around the tube. Optionally, the tape may be covered in a fine layer of adhesive (of the polyethylene, olefin thermoplastic elastomer, or polyurethane type), on one or both faces so as to adhere to the layers situated immediately under and/or over it. The adhesive provides better bursting strength (about 50 bars) but leads to lower flexibility. Both options are compatible with the Specification and either can be selected by the end user.

By way of example, the mechanical reinforcement 5 is made by braiding, knitting, or winding reinforcing fibers of polyamide, polyester, or aramid type, or any other fibers that improves bursting strength. In this example the polyamide (or polyester) fibers that are used are of about 400 decitex (dtex). Winding is preferred since it enables better flexibility to be obtained.

The outer layer 6 is made of polyamide, such as a plasticizer polyamide 12 (PA12), with thickness lying in the range 0.5 mm to 3 mm, for example, and it serves to protect the reinforcement against external aggression.

The outer tube 2 comprises, from the inside towards the outside: an inner layer 7, a taped intermediate layer 8, and an outer layer 9.

The inner layer 7 is made of polyamide, such as plasticized polyamide 12 (PA12). The inner layer 7 is corrugated with the corrugations extending helically. The inner layer 7 has a minimum inside diameter D greater than the outside diameter d of the inner tube 1, and its thickness lies in the range 1.5 mm to 3 mm. The corrugations enable fluid to flow between the inner tube 1 and the outer tube 2.

The intermediate layer 8 is formed by an aluminum-coated polyester tape like the intermediate layer 4 of the inner tube 1.

The outer layer 9 is made of polyamide, such as a plasticizer polyamide 12 (PA12), having a thickness of 0.5 mm to 2.5 mm, for example.

It should be observed that the corrugations perform two functions:

it defines a helical space for fluid flow, such as the fluid that escapes from the inner tube 1 in the event of a leak; and

it enables expansion of the outer tube to be compensated since the facing wall portions of the corrugations can move towards each other by elastic deformation, such that the overall elongation of the outer tube as a result of expansion is zero or small.

The pipe is fabricated in an extrusion line by means of the method described below.

The fabrication method begins by making the inner tube.

The inner layer 3 is extruded in a die 100, is calibrated and then cooled prior to being taped in a station 110 for making up the intermediate layer 4. The cooled inner layer 3 serves to support the tape during taping.

In a winding station 120, the reinforcing fibers are assembled on the intermediate layer 4 in order to form the reinforcement 5.

The outer layer 6 is deposited on the reinforcement 5 in a die 130.

The inner tube 1 as made in this way is fed into a die 140 for extruding the inner layer 7 of the outer tube 2. At the outlet from the die 140, shells 150 are pressed against the material leaving the die 140 so as to form the corrugations. It should be observed that positive air pressure is maintained between the inner tube 1 and the material leaving the die 140 so as to prevent it from sticking to the inner tube 1.

The corrugated inner layer 7 is cooled and the tape of the intermediate layer 8 is deposited on the inner layer 7 in a taping station 160.

The outer layer 9 is extruded onto the intermediate layer 8 in a die 170.

Naturally, the invention is not limited to the embodiments described, and it covers variant embodiments coming within the ambit of the invention as defined by the claims.

In particular, the number of layers in the pipe can be modified. Thus, in a variant, a polyester tape laid lengthwise with overlap can be added between the inner tube 1 and the outer tube 2. Its function is to prevent the inner tube 1 and the outer tube 2 adhering to each other, in particular during the tandem extrusion. The inner layer 7 of the outer tube 2 may then have a minimum inside diameter that is substantially equal to the outside diameter of the inner tube 1.

The materials used for the layers may also be modified. The inner layer 3 of the inner tube 1 may be thus be made of polyvinylidene fluoride.

1. A pipe for transporting fuel, the pipe comprising an inner tube and an outer tube that are coaxial, with a space being maintained between them by spacer means, wherein the outer tube comprises an outer layer and an inner layer, the inner layer being helically corrugated and free relative to the inner tube so as to form the spacer means.

2. A pipe according to claim 1, wherein the inner layer of the outer tube has a minimum inside diameter that is greater than the outside diameter of the inner tube.

3. A pipe according to claim 1, wherein the outer tube has an intermediate layer formed by a tape surrounding the inner layer.

4. A pipe according to claim 3, wherein the inner layer of the outer tube is made of polyamide.

5. A pipe according to claim 3, wherein the tape of the intermediate layer of the outer tube is made of aluminum-coated polyester.

6. A pipe according to claim 3, wherein the outer layer of the outer tube is made of polyamide.

7. A pipe according to claim 1, wherein, going from the inside towards the outside, the inner tube comprises: an inner layer, a taped intermediate layer, tubular reinforcement of reinforcing fibers, and an outer layer.

8. A pipe according to claim 7, wherein the inner layer of the inner tube is made of polyamide.

9. A pipe according to claim 7, wherein the taped intermediate layer of the inner tube comprises a tape of aluminum-coated polyester surrounding the inner layer.

10. A pipe according to claim 7, wherein the tubular reinforcement of reinforcing fibers comprises polyamide fibers, polyester fibers, or aramid fibers.

11. A pipe according to claim 7, wherein the outer layer of the inner tube is made of polyamide.

12. A method of fabricating a pipe for transporting fuel, the method comprising the steps of:
making an inner tube;
passing the inner tube through an extruder die;
at the outlet from the extruder die, forming helical corrugations around the inner tube in the material being delivered by the die so as to constitute an inner layer of an outer tube that is free relative to the inner tube;
taping the inner layer with a tape so as to form a taped intermediate layer of the outer tube; and
extruding an outer layer of the outer tube.
